(19) United States
(12) Patent Application Publication
(10) Pub. No.: US 2012/0059786 A1
(43) Pub. Date: Mar. 8, 2012

(54) METHOD AND AN APPARATUS FOR MATCHING DATA NETWORK RESOURCES

(76) Inventors: Walter Christian Kammergruber, Reut (DE); Werner Zucker, Munchen (DE)

(21) Appl. No.: 12/904,741

(22) Filed: Oct. 14, 2010

(30) Foreign Application Priority Data
Sep. 2, 2010 (EP) 10009138

(51) Int. Cl. G06N 5/02

(52) U.S. Cl. 706/50

(57) ABSTRACT

A method and apparatus for matching data network resources with an appropriate group of concepts of an ontology has the steps of, receiving a request indicating at least one expert field, providing at least one data network resource of the expert field having at least one tag and an ontology of the expert field having at least one concept, determining a minimum spanning tree of the concepts in the ontology corresponding to the tags of the data network resources and returning the concepts of the selected minimum spanning tree in response to the received request. The data network resources is matched thematically related to concepts of an ontology to the concepts of an ontology without knowing the exact terms used in the concepts and vice versa. It can be used by experts to search resources created by laymen using their expert terms without the need to know these terms.

### CROSS-REFERENCE TO RELATED APPLICATIONS

This application claims priority to EP Patent Application No. 10009138 filed Sep. 2, 2010. The contents of which is incorporated herein by reference in its entirety.

### TECHNICAL FIELD

The invention relates generally to the field of matching data network resources with an appropriate group of concepts of an ontology.

### BACKGROUND

It is known in the art to match search terms submitted within a search request to terms included in data network resources. For example search engines have two possibilities to match a search term. Search engines can either match the whole search term by comparing the search term to the terms included in data network resources letter by letter or they can match the search term to subterms of the terms included in data network resources. In this case the search engine analyses weather the search term is included as a whole in one of the terms of the data network resources. After matching the search term to terms of data network resources the search engine provides a user who submitted the search terms with links to those data network resources that contain at least one of the search terms.

However it is not possible to match terms to resources that correspond to the same field but do not include the exact search terms.

### SUMMARY

According to various embodiments, a method for matching data resources to concepts belonging to the same field as the data resources without including exactly the same terms can be provided.

According to an embodiment, a method for matching data network resources with an appropriate group of concepts of an ontology may comprise the steps of: a) receiving a request indicating at least one expert field; b) providing at least one data network resource of said expert field having at least one tag and an ontology of said expert field having at least one concept; c) determining a minimum spanning tree of said concepts in said ontology corresponding to said tags of said data network resources; and d) returning the concepts of said selected minimum spanning tree in response to the received request.

According to a further embodiment, the step of determining a minimum spanning tree may comprises the following steps: calculating a distance between each of said tags of said data network resources and each of at least one label corresponding to said concepts of said ontology; selecting potential concepts for each tag for which the distance to said tag is lower than a distance threshold value and determining all n-tuples of said potential concepts for each tag, n being the number of tags of the respective data network resource; and calculating a minimum spanning tree for each of said n-tuples and the sum of edge weights of said calculated minimum spanning tree and selecting the minimum spanning tree having the minimum sum of edge weights. According to a further embodiment, each data network resource may have a Unique Resource Identifier (URI) and comprises at least one of the following resources: web pages, and/or

web logs, and/or web forums, and/or news servers, and/or
documents. According to a further embodiment, said tags may comprise means configured to characterise the data network resource, preferably said means comprise: terms of a natural language, and/or pictures, and/or figures, and/or numbers. According to a further embodiment, the step of calculating a distance may comprise using at least one distance algorithm, said distance algorithm using at least one of the following string metrics: Hamming distance, Levenshtein distance and Damerau-Levenshtein distance, Needleman-Wunsch distance or Sellers' algorithm, Smith-Waterman distance, Gotoh distance, Monge Elkan distance, Block distance or L1 distance or City block distance, Jaro-Winkler distance, Soundex distance metric, Matching coefficient, Dice's coefficient, Jaccard similarity or Jaccard coefficient or Tanimoto coefficient, Overlap coefficient, Euclidean distance or L2 distance, Cosine similarity, Variational distance, Hellinger distance or Bhattacharyya distance, Information radius (Jensen-Shannon divergence), Harmonic mean, Skew divergence, Confusion probability, Tau metric, an approximation of the Kullback-Leibler divergence, Fellegi and Sunters metric (SFS), TFIDF or TF/IDF, and Maximal matches. According to a further embodiment, said distance threshold value can be a value between 0 and 1, and preferably a value between 0.5 and 0.9. According to a further embodiment, said ontology may comprise the Radlex Ontology or the Gene Ontology.

According to another embodiment, an apparatus for matching data network resources of a data network with an appropriate group of concepts of an ontology may comprise: a) at least one interface to said data network for receiving a request indicating at least one expert field from a requesting unit connected to said data network, wherein at least one data network resource comprising at least one tag is accessible by means of said network interface; b) means for accessing a memory which stores at least one ontology of said expert field, said ontology comprising at least one concept; and c) a minimum spanning tree determination unit provided to determine a minimum spanning tree of said concepts in the stored ontology corresponding to said tags of said data network resources; d) wherein the concepts of said selected minimum spanning tree are returned by means of said network interface to said requesting unit.

According to a further embodiment of the apparatus, the minimum spanning tree determination unit comprises: a distance calculation unit provided to calculate a distance between each of said tags of said data network resources and each of the concepts of the stored ontology; a selection unit provided to select potential concepts for each tag for which the calculated distance to said tag is lower than a distance threshold value; a determination unit configured to determine all n-tuples of said potential concepts for each tag, n being the number of tags of the data network resource; a spanning tree calculation unit adapted to calculate a minimum spanning tree for each of said determined n-tuples and the sum of edge weights of said calculated minimum spanning tree; and a minimum spanning tree selection unit provided to select the minimum spanning tree having a minimum sum of edge weights. According to a further embodiment of the apparatus, each data network resource has a Unique Resource Identifier (URI) and comprises at least one of the following resources: web pages, and/or web logs, and/or web forums, and/or news servers, and/or documents. According to a further embodiment of the apparatus, said tags may comprise means configured to characterise the data network resource, preferably said means comprise: terms of a natural language, and/or pictures, and/or figures, and/or numbers. According to a further embodiment of the apparatus, said distance calculation unit can be adapted to calculate a distance using at least one distance algorithm, said distance algorithm using at least one of the following string metrics: Hamming distance, Levenshtein distance and Damerau-Levenshtein distance, Needleman-Wunsch distance or Sellers' algorithm, Smith-Waterman distance, Gotoh distance, Monge Elkan distance, Block distance or L1 distance or City block distance, Jaro-Winkler distance, Soundex distance metric, Matching coefficient, Dice's coefficient, Jaccard similarity or Jaccard coefficient or Tanimoto coefficient, Overlap coefficient, Euclidean distance or L2 distance, Cosine similarity, Variational distance, Hellinger distance or Bhattacharyya distance, Information radius (Jensen-Shannon divergence), Harmonic mean, Skew divergence, Confusion probability, Tau metric, an approximation of the Kullback-Leibler divergence, Fellegi and Sunters metric (SFS), TFIDF or TF/IDF, and Maximal matches. According to a further embodiment of the apparatus, said apparatus may comprise a configuration interface for adapting said distance threshold value to a value between 0 and 1, and preferably a value between 0.5 and 0.9. According to a further embodiment of the apparatus, said apparatus can be connected to said data network via said network interface by means of a wireless or wired link. According to a further embodiment of the apparatus, said apparatus can be a server connected to the data network receiving the request from a client and returning concepts of the selected minimum spanning tree or the selected data network resources to said client.

According to yet another embodiment, a method for matching at least one concept of an ontology with an appropriate group of data network resources may comprise the steps of: a) receiving a request comprising at least one concept of an ontology of an expert field; b) providing at least one data network resource corresponding to said expert field having at least one tag and an ontology corresponding to said expert field having at least one concept; c) determining a minimum spanning tree of said concepts in said ontology corresponding to said tags of said data network resources; d) providing a database configured to store pairs of said data network resources and said selected minimum spanning trees and storing calculated pairs of said resources comprising tags and said selected minimum spanning tree in said database; e) selecting at least one data network resource matching said at least one concept based on data stored in said database; and f) returning the selected data network resources corresponding to said at least one concept in response to the received request.

According to a further embodiment of the above method, the step of determining a minimum spanning comprises the following steps: calculating a distance between each of said tags of said data network resources and each of at least one labels corresponding to said concepts of said ontology; selecting potential concepts for each tag for which the distance to said tag is lower than a distance threshold value and determining all n-tuples of said potential concepts for each tag, n being the number of tags of the respective resource; and calculating a minimum spanning tree for each of said n-tuples and the sum of the edge weights of said calculated minimum spanning tree and selecting the minimum spanning tree having the minimum sum of edge weights. According to a further embodiment of the above method, each data network resource has a Unique Resource Identifier (URI) and comprises at least one of the following resources: web pages, and/or web logs, and/or web forums, and/or

news servers, and/or documents. According to a further embodiment of the above method, said tags comprise means configured to characterise the data network resource, preferably said means comprise: terms of a natural language, and/or pictures, and/or figures, and/or numbers. According to a further embodiment of the above method, the step of calculating a distance may comprise using at least one distance algorithm, said distance algorithm using at least one of the following string metrics: Hamming distance, Levenshtein distance and Damerau-Levenshtein distance, Needleman-Wunsch distance or Sellers' algorithm, Smith-Waterman distance, Gotoh distance, Monge Elkan distance, Block distance or L1 distance or City block distance, Jaro-Winkler distance, Soundex distance metric, Matching coefficient, Dice's coefficient, Jaccard similarity or Jaccard coefficient or Tanimoto coefficient, Overlap coefficient, Euclidean distance or L2 distance, Cosine similarity, Variational distance, Hellinger distance or Bhattacharyya distance, Information radius (Jensen-Shannon divergence), Harmonic mean, Skew divergence, Confusion probability, Tau metric, an approximation of the Kullback-Leibler divergence, Fellegi and Sunters metric (SFS), TFIDF or TF/IDF, and Maximal matches. According to a further embodiment of the above method, said distance threshold value may be adjusted to a value between 0 and 1, and preferably a value between 0.5 and 0.9.

According to yet another embodiment, an apparatus for matching at least one concept of an ontology with at least a single most appropriate group of data network resources of a data network comprising: a) at least one network interface to said data network for receiving a request comprising at least one concept of an ontology of an expert field, wherein at least one data network resource comprising at least one tag is accessible by means of said network interface; b) means for accessing a memory which stores at least one ontology of said expert field comprising at least one concept; c) a minimum spanning tree determination unit provided to determine minimum spanning trees of said concepts in the stored ontology corresponding to said tags of said data network resources; d) providing a database which stores pairs of said data network resources and said selected minimum spanning trees and which stores calculated pairs of said data network resources comprising tags and said selected minimum spanning tree; and e) a resource selection unit configured to select at least one data network resource matching said at least one concept based on data stored in said database, wherein the selected data network resources correspond to said at least one concept and are returned by means of said network interface in response to the received request.

According to a further embodiment of the above apparatus, said minimum spanning tree determination unit may comprise: a distance calculation unit provided to calculate a distance between each of said tags of said data network resources and each of the concepts of the stored ontology; a selection unit provided to select potential concepts for each tag for which the calculated distance to said tag is lower than a distance threshold value and a determination unit adapted to determine all n-tuples of said potential concepts for each tag, n being the number of tags of the resource; a spanning tree calculation unit adapted to calculate a minimum spanning tree for each of said determined n-tuples and the sum of edge weights of said calculated minimum spanning tree; and a minimum spanning tree selection unit configured to select the minimum spanning tree having a minimum sum of edge weights.

According to yet another embodiment, an expert system may comprise at least one of the apparatus as described above.

### BRIEF DESCRIPTION OF THE DRAWINGS

Other objects and advantages may become apparent upon reading the detailed description and upon reference to the accompanying drawings.

FIG. 1 is a flow diagram illustrating a possible embodiment of a method for matching data network resources with an appropriate group of concepts of an ontology;

FIG. 2 shows a block diagram of a possible embodiment of a matching apparatus;

FIG. 3 is a flow diagram illustrating a possible embodiment of a method for matching at least one concept of an ontology with an appropriate group of data network resources;

FIG. 4 shows a block diagram of a possible embodiment of a matching apparatus;

FIG. 5 shows a diagram illustrating a matching apparatus, a requesting unit, a data network, data network resources and a user according to a possible embodiment;

FIG. 6 shows a graph and a minimal spanning tree in that graph as employed by the method;

FIG. 7 illustrates the idea of matching tags of data network resources with concepts of an ontology;

FIG. 8 shows a set of potential concepts for a tag;

FIG. 9 shows potential concepts for a number n of tags.

### DETAILED DESCRIPTION

An aspect is to provide a method for matching data network resources with an appropriate group of concepts of an ontology comprising the steps of receiving a request indicating at least one expert field, providing at least one data network resource of said expert field having at least one tag and an ontology of said expert field having at least one concept, determining a minimum spanning tree of said concepts in said ontology corresponding to said tags of said data network resources and returning the concepts of said selected minimum spanning tree in response to the received request.

A further aspect is to provide an apparatus for matching data network resources of a data network with an appropriate group of concepts of an ontology comprising at least one interface to said data network for receiving a request indicating at least one expert field from a requesting unit connected to said data network, wherein at least one data network resource comprising at least one tag is accessible by means of said network interface, means for accessing a memory which stores at least one ontology of said expert field, said ontology comprising at least one concept and a minimum spanning tree determination unit provided to determine a minimum spanning tree of said concepts in the stored ontology corresponding to said tags of said data network resources wherein the concepts of said selected minimum spanning tree are returned by means of said network interface to said requesting unit.

A further aspect is to provide a method for matching at least one concept of an ontology with an appropriate group of data network resources, said method comprising the steps of receiving a request comprising at least one concept of an ontology of an expert field, providing at least one data network resource corresponding to said expert field having at least one tag and an ontology corresponding to said expert field having at least one concept, determining a minimum spanning tree of said concepts in said ontology corresponding to said tags of said data network resources, providing a database configured to store pairs of said data network resources and said selected minimum spanning trees and storing calculated pairs of said resources comprising tags and said selected minimum spanning tree in said database, selecting at least one data network resource matching said at least one concept based on data stored in said database and returning the selected data network resources corresponding to said at least one concept in response to the received request.

A further aspect is to provide an apparatus for matching at least one concept of an ontology with at least a single most appropriate group of data network resources of a data network comprising at least one network interface to said data network for receiving a request comprising at least one concept of an ontology of an expert field, wherein at least one data network resource comprising at least one tag is accessible by means of said network interface, means for accessing a memory which stores at least one ontology of said expert field comprising at least one concept, a minimum spanning tree determination unit provided to determine minimum spanning trees of said concepts in the stored ontology corresponding to said tags of said data network resources, providing a database which stores pairs of said data network resources and said selected minimum spanning trees and which stores calculated pairs of said data network resources comprising tags and said selected minimum spanning tree and a resource selection unit configured to select at least one data network resource matching said at least one concept based on data stored in said database, wherein the selected data network resources correspond to said at least one concept and are returned by means of said network interface in response to the received request.

The various embodiments disclosed allow the matching of data network resources thematically related to concepts of an ontology to said concepts of an ontology without knowing the exact terms used in said concepts and vice versa. Thus providing a layman with the capability to better understand an expert's language and the expert with the capability of finding data network resources created by said laymen comprising his field of expertise without knowing the exact terms used by said laymen.

For example the expert field can be Radiology and the data network resource can be a community related to Thyroid Disorder, for example the MedHelp Community Thyroid Disorder. In this case an expert in the field of radiology can use the various embodiments to find entries in said community dealing with the special field of radiology without knowing the terms the users of said community use in their writings. On the other hand a user of said community can use his own terms and entries in said community to search for experts or documents written by experts about that topic. In another case the topic can be “diabetes” and a user can try the search term “sugar”. The various embodiments would help said user to find experts in the field of diabetes.

In a possible embodiment the step of determining a minimum spanning tree comprises the steps of calculating a distance between each of said tags of said data network resources and each of at least one label corresponding to said concepts of said ontology, selecting potential concepts for each tag for which the distance to said tag is lower than a distance threshold value and determining all n-tuples of said potential concepts for each tag, n being the number of tags of the respective data network resource and calculating a minimum spanning tree for each of said n-tuples and the sum of edge weights of said calculated minimum spanning tree and selecting the minimum spanning tree having the minimum sum of edge weights. With these steps it is possible to select an appropriate group of concepts corresponding to the request without having an exact match between the terms included in the request and the concepts of the ontology.

In a possible embodiment each data network resource has a Unique Resource Identifier (URI) and comprises at least one of the following resources:

web pages, and/or
web logs, and/or
web forums, and/or
news servers, and/or
documents.

By using data network resources having URIs a confusion of different data network resources can be excluded and by using the above mentioned resources a multitude of different data network resources can be included in the matching process, thus providing a broad result set.

In a possible embodiment said tags comprise means configured to characterise the data network resource, preferably said means comprise:

terms of a natural language, and/or
pictures, and/or
figures, and/or
numbers.

Not all data network resources are characterised by words or terms of a natural language. By allowing the data network resources to be characterized by other means than terms better matching and thus a better result set for said matching can be provided.

In a possible embodiment the step of calculating a distance comprises using at least one distance algorithm, said distance algorithm using at least one of the following string metrics:

Hamming distance,
Levenshtein distance and Damerau-Levenshtein distance,
Needleman-Wunsch distance or Sellers' algorithm,
Smith-Waterman distance,
Gotoh distance,
Monge Elkan distance,
Block distance or L1 distance or City block distance,
Jaro-Winkler distance,
Soundex distance metric,
Matching coefficient,
Dice's coefficient,
Jaccard similarity or Jaccard coefficient or Tanimoto coefficient,
Overlap coefficient,
Euclidean distance or L2 distance,
Cosine similarity,
Variational distance,
Hellinger distance or Bhattacharyya distance,
Information radius (Jensen-Shannon divergence),
Harmonic mean,
Skew divergence,
Confusion probability,
Tau metric, an approximation of the Kullback-Leibler divergence,
Fellegi and Sunters metric (SFS),

### TFIDF or TF/IDF, and

Maximal matches.

Using string metrics makes the comparison of two strings more accurate than for example comparing string lengths. By using string metrics it is possible to match a first string comprising one term to a second string comprising another term that is a variation of said first string. For example with a string metric the string “nodule” can be matched to the string “nodulus”.

In a possible embodiment a distance threshold value is a value between 0 and 1, and preferably a value between 0.5 and 0.9.

In a possible embodiment said ontology comprises the Radlex Ontology or the Gene Ontology. Other ontologies are also possible. Using expert ontologies guarantees that the concepts appearing in said ontology are standardized concepts common to all experts of that special field.

In a possible embodiment the minimum spanning tree determination unit comprises a distance calculation unit provided to calculate a distance between each of said tags of said data network resources and each of the concepts of the stored ontology, a selection unit provided to select potential concepts for each tag for which the calculated distance to said tag is lower than a distance threshold value, a determination unit configured to determine all n-tuples of said potential concepts for each tag, n being the number of tags of the data network resource, a spanning tree calculation unit adapted to calculate a minimum spanning tree for each of said determined n-tuples and the sum of edge weights of said calculated minimum spanning tree and a minimum spanning tree selection unit provided to select the minimum spanning tree having a minimum sum of edge weights. With these elements it is possible to select an appropriate group of concepts corresponding to the request without having an exact match between the terms included in the request and the concepts of the ontology.

In a possible embodiment the apparatus comprises a configuration interface for adapting said distance threshold value to a real number, preferably a value between 0 and 1, and more preferably a value between 0.5 and 0.9. By using a configuration interface to adapt the distance threshold value it is possible to influence the matching results and exchange accuracy of the matching results for number of matching results.

In a possible embodiment the apparatus is connected to said data network via said network interface by means of a wireless or wired link. A wired link makes it possible to use a stationary computing apparatus for the matching. The wireless link allows the use of a transportable computing device. This could be a notebook or a mobile phone.

In yet another respect disclosed is that the apparatus is a server connected to the data network receiving the request from a client and returning concepts of the selected minimum spanning tree or the selected data network resources to said client.

One or more embodiments are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

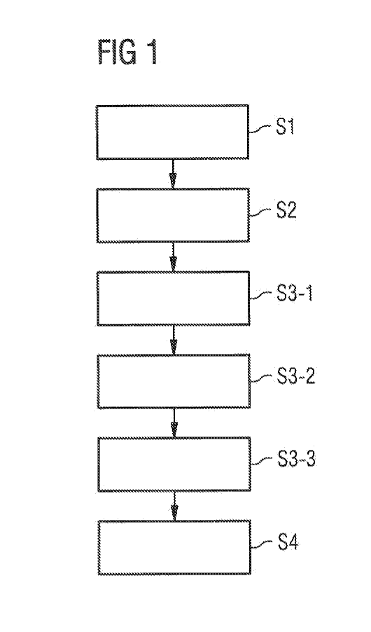

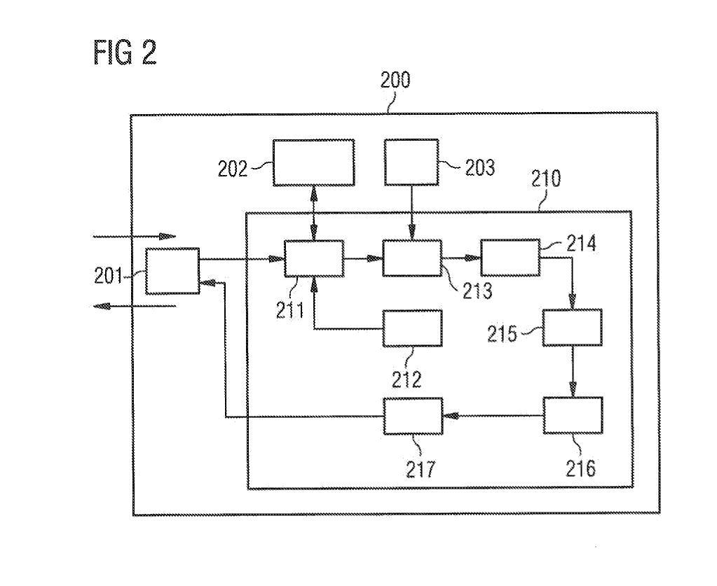

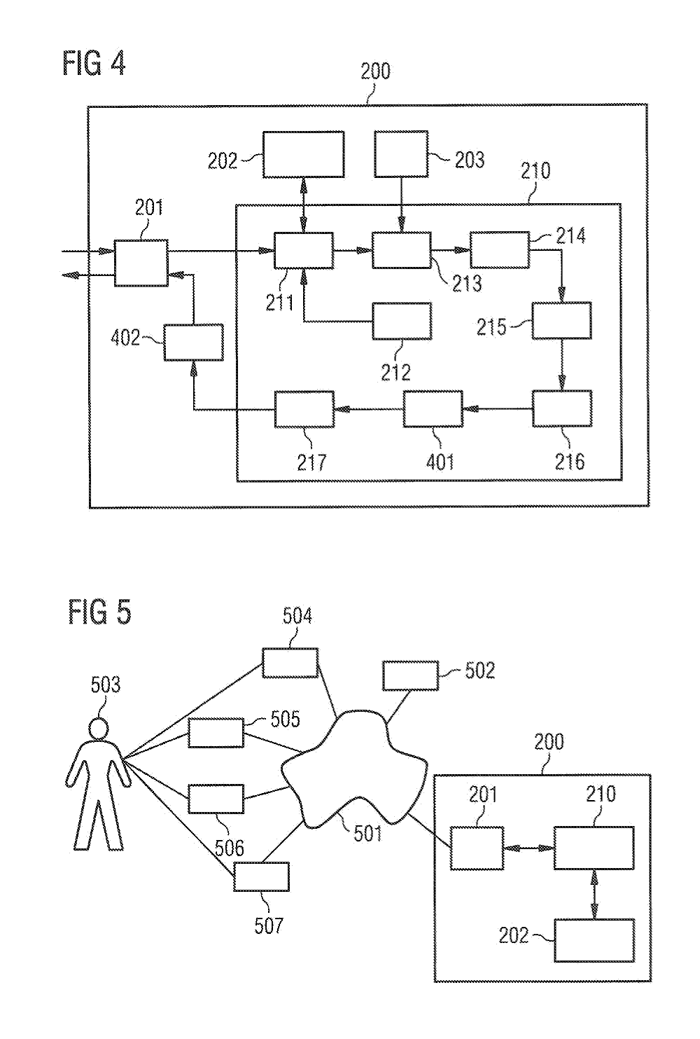

FIG. 1 is a flow diagram illustrating a method for matching data network resources with an appropriate group of concepts of an ontology, in accordance with some embodiments. In some embodiments, the method illustrated in FIG. 1 may be performed by one or more of the systems shown in FIG. 2 or FIG. 4. Processing begins at step S1 continues with the step S2 and then step S3 and finally step S4. Step S3 is divided into three single sub-steps S3-1, S3-2 and S3-3.

In step S1 a request indicating at least one expert field is received, this request can be generated by a user using a web frontend of a web server that forwards said request to the matching apparatus.

In step S2 at least one data network resource of said expert field is provided. A data network resource can be a resource created by a user comprising content related to an expert field. Each data network resource has at least one tag wherein the tags comprise terms of a natural language such as English or German and/or numbers and/or pictures. A data network resource can comprise text, pictures and audio or audiovisual information. The tags t₁ to tₙ indexing a resource i are called the Tag-Assignment TA(res(i)) of resource i.

TA(res(i))=(t(i,1),t(i,2), . . . t(i,n))

t(i,j) being the tag number j of the resource i.

Furthermore in step S2 at least one ontology of the respective expert field is provided. This ontology has at least one concept. The ontologies can comprise medical ontologies, technical ontologies or any other ontology comprising at least one concept. Concepts are elements of an ontology. Sometimes concepts are also called classes. In concepts common attributes are characterised as a term. Concepts for example can be “goiter”, “biopsy””, “car” or “house”.

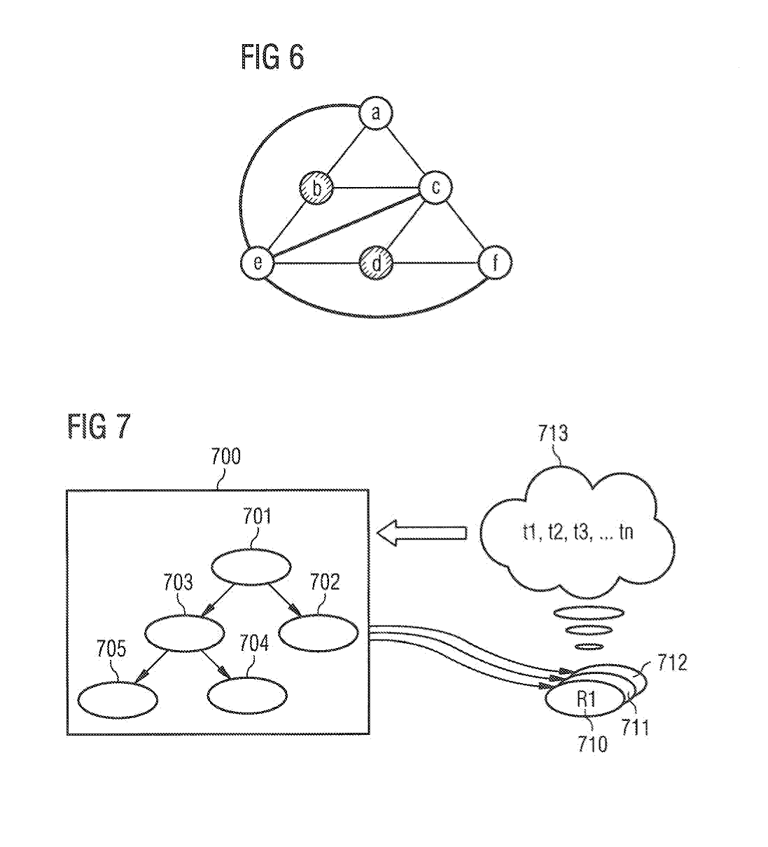

In step S3 a minimum spanning tree is determined for those concepts of the ontology that correspond to the tags of the data network resources. Given a graph G=(V,E) for a set of vertices V′⊂V and a set of edges E⊂E between said vertices, each edge having an edge weight assigned, a spanning tree of that graph is a subgraph which connects selected vertices V′ together. A weight is assigned to each edge of said graph, which is a metric representing how unfavourable the respective link is. The weight is used to assign a weight to a spanning tree by computing the sum of the weights of the edges in that spanning tree. A minimum spanning tree is a spanning tree with a weight less than or equal to the weight of every other spanning tree. For an example of a minimal spanning tree see FIG. 6.

The process of determining the minimum spanning tree comprises sub-step S3-1, in which a standardised distance between each of said tags of said data network resources and each of at least one label corresponding to said concepts of the ontology is calculated. If the tags comprise terms of a natural language the standardised distance between tags and concepts is calculated using string metrics. If the tags comprise pictures, distance algorithms can be used that calculate a distance value for two pictures. If the tags comprise any other means configured to characterise the data network resources a corresponding algorithm can be used that is configured to calculate a distance value between said tags and the concepts of the ontology.

In sub-step S3-2 the calculated standardised distances are compared to a distance threshold value and all concepts are selected for each tag for which the distance value to said tag is lower than a distance threshold value τ. The distance threshold value τ can be any positive real number but is preferably a number between 0 and 1. The set of potential concepts for a tag t(i, j) is determined by the distance threshold value τ. A concept pzk(i, j, k) is included in the set of potential concepts PZK(i, j) for a tag t(i, j) if the distance d between the tag and the concept is lower than the threshold value τ.

d(t(i,j),pzk(i,j,k))≦τ

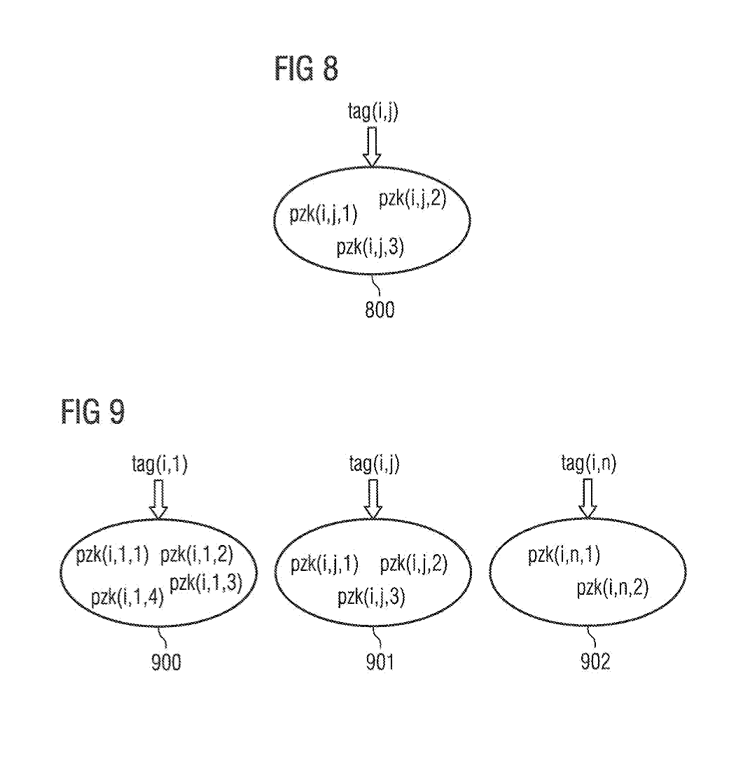

A set of concepts pzk(i, j, t) for a tag t(i, j) is shown in FIG. 8.

In sub-step S3-2 there are further determined all n-tuples of the selected concepts. The number of tags t(i, j) indicates the size n of the tuples. The number of tuples is defined by the Cartesian product Π(i, j=1 . . . n) of the sets PZK(i, j).

Π(i,j=1 . . . n)=PZK(i,1)× . . . ×PZK(i,n)={(pzk(i,1), . . . ,pzk(i,j)|pzk(i,j))εPKz(i,j)}

A group of potential concepts for n tags t(i, j) is shown in FIG. 9.

For a resource comprising three tags the size n of the tuples would be three (n=3). If there are three tags t(i, j) corresponding to one data network resource and there are four concepts for the first tag, three concepts for the second tag and two concepts for the third tag there is a total number of 4*3*2=24 3-tuples.

In the sub-step S3-3 minimal spanning trees T(PZK(i, j), E) and the sum of the edge weights ω(T) of said minimal spanning trees are calculated for all of the above determined n-tuples and the minimal spanning tree with the minimum sum of edge weights ω(T) is selected. The single edge weights are predetermined for an ontology by the builder of said ontology. For the above mentioned 24 3-tuples the sums of the edge weights are given by the following formulas

$$ω ( T ( i , 1 ) ) = ω ( pzk ( i , 1 , 1 ) , pzk ( i , j , 1 ) pzk ( i , n , 1 ) )$$

$$ω ( T ( i , 2 ) ) = ω ( pzk ( i , 1 , 1 ) , pzk ( i , j , 1 ) pzk ( i , n , 2 ) )$$

$$ω ( T ( i , 3 ) ) = ω ( pzk ( i , 1 , 1 ) , pzk ( i , j , 1 ) pzk ( i , n , 3 ) )$$

$$ω ( T ( i , 4 ) ) = ω ( pzk ( i , 1 , 1 ) , pzk ( i , j , 2 ) pzk ( i , n , 1 ) )$$

$$ω ( T ( i , 5 ) ) = ω ( pzk ( i , 1 , 1 ) , pzk ( i , j , 2 ) pzk ( i , n , 2 ) )$$

$$…$$

$$ω ( T ( i , p ) ) = ω ( pzk ( i , 1 , 4 ) , pzk ( i , j , 2 ) pzk ( i , n , 3 ) )$$

The determination of the ω(T(i, 1)) can be done with the algorithm described by Joseph B. Kruskal in “On the Shortest Spanning Subtree of a Graph and the Travelling Salesman Problem, In: Proceedings of the American Mathematical Society, Vol 7, No. 1 (February, 1956), pp. 48-50)

In step S4 the concepts of the minimum spanning tree selected in step S3-3 are returned to the web server that forwarded the request.

In an alternative embodiment the request is generated by a direct user input via a terminal connected directly to the matching apparatus.

In an exemplary embodiment a matching between concepts of the RadLex ontology and entries in the MedHelp Community Thyroid Disorder is performed. If for example the community entry comprises the tags:
nodule, Goiter, Thyroid, biopsied, nodules, radiologist and ultrasound
   and the distance threshold value τ is 0.7 and the distance between above tags and the concepts of the RadLex ontology is determined with the Levensthtein Distance algorithm the following potential concepts are determined in the ontology:
   nodule: nodulus, nodule, lobule, nodular
   nodules: nodulus, nodule, nodular
   radiologist: radiolucent
   biopsied: biopsy, biopsy
   thyroid: thyroiditis
   goiter: goiter
   ultrasound: ultrasound, 3D ultrasound

The minimum spanning tree determined with the above described algorithm returns the following concepts as being the semantically most similar concepts to the tags of the resource:
“lobule” “nodulus” “radiolucent” “biopsy” “thyroiditis” “goiter” “3D ultrasound”

For the calculation of ω(T) the following edge weights were used for the edges of the RadLex ontology:

| Edge/RadLex Relation | cost |
|---|---|
| is_a | 0.1 |
| part_of | 0.4 |
| containedin | 0.5 |
| branchof | 0.7 |
| synonymof | 0.05 |
| tributaryof | 0.8 |
| segmentof | 0.5 |
| continuouswith | 0.5 |
| empty | 2.0 |

FIG. 2 shows a block diagram of a matching apparatus 200 according to a possible embodiment wherein the matching apparatus 200 comprises an interface 201 coupled to a minimum spanning tree determination unit 210, an ontology memory 202 and a configuration interface 203, where the ontology memory 202 and the configuration interface 203 are coupled to the minimum spanning tree determination unit 210. Furthermore the minimum spanning tree determination unit 210 comprises a distance calculation unit 211 coupled to the interface 201 and to the ontology memory 202, a program memory 212 coupled to the distance calculation unit 211, a selection unit 213 coupled to the distance calculation unit 211 and to the configuration interface 203, a determination unit 214 coupled to the selection unit 213, a spanning tree calculation unit 215 coupled to the determination unit 214, a minimum spanning tree selection unit 216 coupled to the spanning tree calculation unit 215 and a concept extraction unit 217 coupled to the minimum spanning tree selection unit 216 and the network interface 201.

The interface 201 can comprise an Ethernet interface 201 which is configured to receive a request from an Ethernet network via a TCP/IP connection and forward said request to the minimum spanning tree calculation unit 210 and to provide data network resources for the matching apparatus 200. In an alternative embodiment the interface 201 comprises a wireless interface, e.g. a WiFi interface or a UMTS interface. The data network can be the internet.

The distance calculation unit 211 of the minimal spanning tree determination unit 210 loads an ontology corresponding to a received request from the ontology memory 202 and uses string metric calculation algorithms loaded from the program memory 212 to calculate a distance between the concepts of the loaded ontology and the tags of the provided data network resources. The distance calculation unit 211 then supplies the calculated distances to the selection unit 213. In an alternative embodiment the distance calculation unit 211 calculates a distance using picture distance algorithms.

The selection unit 213 receives a minimal distance threshold value via the configuration interface 203 and selects all pairs of concepts and tags for which the distance is lower than said distance threshold value. The selected tags and concepts are then forwarded to the determination unit 214. In an alternative embodiment the distance is not a distance value, with a value of 1 corresponding to identical terms, but a distance value, with a value of 0 corresponding to identical terms, and the distance is compared to a maximum distance threshold value. Pairs of concepts and tags are returned if the calculated distance is lower than the maximum distance threshold value.

The determination unit 214 determines all n-tuples of the selected concepts received from the selection unit 213.

The spanning tree calculation unit can 215 calculates the minimum spanning tree and the sum of the edge weights for all of the determined n-tuples.

The minimum spanning tree selection unit 216 selects the minimum spanning tree having the minimal sum of edge weights of all of the calculated spanning trees.

The extraction unit 217 extracts the concepts of the selected minimum spanning tree and forwards the concepts to the network interface 201.

All the components of the minimum spanning tree calculation unit 210 can comprise an application specific integrated circuit (ASIC) or a microcontroller programmed to execute the given task. In an alternative embodiment all the components of the minimum spanning tree calculation unit 210 are provided as computer program modules configured to run on a server. All of said components can be implemented in one ASIC or can be configured to run on the same microcontroller or server or they can be implemented in different ASICs or can be configured to run on different microcontrollers or servers.

The ontology memory 202 comprises in a possible embodiment a database server configured to store ontologies. In alternative embodiments the ontology memory comprises a Random Access Memory (RAM) and/or a hard disk drive configured to store the ontologies. In yet another embodiment the ontology memory 202 comprises a database embedded in the minimum spanning tree determination unit 210.

The configuration interface 203 can be a local network interface. In an alternative embodiment the interface 203 is the same interface as the network interface 201.

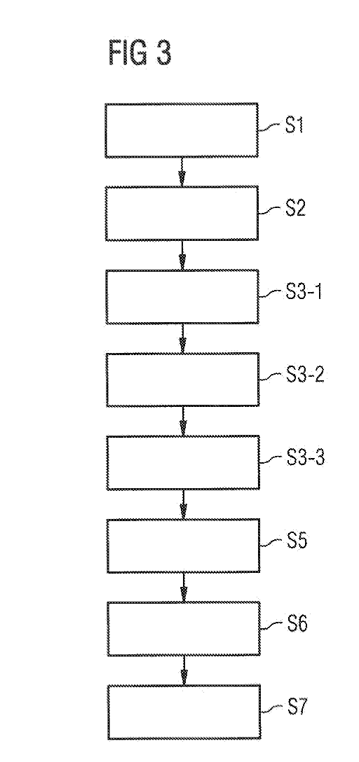

FIG. 3 is a flow diagram illustrating a method for matching concepts of an ontology with appropriate data network resources, in accordance with some embodiments. The method provided in FIG. 3 executes a reverse matching compared to the method shown in FIG. 1. In some embodiments, the method illustrated in FIG. 3 may be performed by one or more of the systems shown in FIG. 2 or FIG. 4. Processing begins at step S1 continues with steps S2, S3, S5 and S6 and ends at step S7. Step S3 is divided into three sub-steps S3-1, S3-2 and S3-3. The difference to FIG. 1 is that no step S4 exists and the additional steps S5, S6 and S7 are executed in order to match said concepts with appropriate data network resources.

The steps S1, S2, S3, S3-1, S3-2 and S3-3 are the same as for FIG. 1.

In step S5 pairs of resources comprising tags and the corresponding selected minimum spanning tree for said resources are stored in a database. In an alternative embodiment unique resource identifiers (URIs) are stored in said database.

The steps S1 to S5 are repeated for various data network resources. Thus said database holds pairs of concepts corresponding to data network resources and a selection of data network resources based on a given concept can easily and efficiently be done.

In step S6 data network resources corresponding to concepts of the expert field indicated by the request are loaded from said database.

In step S7 the data network resources or the URIs of said data network resources are returned to the web server that has forwarded the request.

FIG. 4 shows a block diagram of a matching apparatus 200 according to a further possible embodiment. Matching apparatus 200 of FIG. 4 comprises an interface 201 coupled to a minimum spanning tree determination unit 210, an ontology memory 202 and a configuration interface 203, where the ontology memory 202 and the configuration interface 203 are coupled to the minimum spanning tree determination unit 210. Furthermore the minimum spanning tree determination unit 210 comprises a distance calculation unit 211 coupled to the interface 201 and to the ontology memory 202, a program memory 212 coupled to the distance calculation unit 211, a selection unit 213 coupled to the distance calculation unit 211 and to the configuration interface 203, a determination unit 214 coupled to the selection unit 213, a spanning tree calculation unit 215 coupled to the determination unit 214, a minimum spanning tree selection unit 216 coupled to the spanning tree calculation unit 215, a second database 401 coupled to the minimum spanning tree selection unit 216, a concept extraction unit 217 coupled to the second database 401 and the network interface 201.

The components 201, 202, 203, 211, 212, 213, 214, 215 and 216 are the same as in FIG. 2.

The second database 401 shown in FIG. 4 is a database server configured to store pairs of data network resources and minimum spanning trees. In alternative embodiments the second database 401 comprises Random Access Memory (RAM) and/or a hard disk drive configured to store pairs of data network resources and minimum spanning trees. In yet another embodiment the second database 401 comprises a database embedded in the ontology database 202.

In FIG. 4 the extraction unit 217 loads pairs of resources and minimum spanning trees from the second database 401, wherein the pairs are selected from the second database 401 if the minimum spanning tree comprises the concepts of the request. The extraction unit 217 provides the resources to the network interface to generate a response to the request.

In an embodiment the apparatus of FIG. 2 and of FIG. 4 comprise the same apparatus configured to execute both types of matching. In yet another embodiment the components of FIG. 2 and FIG. 4 are computer program products configured to be run on a server.

FIG. 5 shows a diagram illustrating a data network 501, a matching apparatus 200 comprising an interface 201, a minimum spanning tree determination unit 210 and an ontology memory 202, coupled to a the data network 501, a requesting unit 502 coupled to the data network 501, data network resources 504, 505, 506, 507 each coupled to the data network 501 and a user 503 coupled to the data network resources 504, 505, 506, 507.

The matching apparatus 200 is the apparatus as shown in FIG. 2. It is connected to the data network 501 to perform matching upon receiving a request.

The requesting unit 502 can be a personal computer connected to the data network 501 configured to provide requests to the interface 201 of the matching apparatus 200. In an alternative embodiment the requesting unit 502 is a mobile device connected to the data network 501 via a wireless data connection, e.g. a WiFi connection or a UMTS connection.

The data network resources 504, 505, 506, 507 are data network resources having tags provided to be accessed by the matching apparatus 200 via the data network 501. These resources can comprise web sites, web blogs, news servers and ftp servers. In an alternative embodiment the data network resources 504, 505, 506, 507 are stored on a backup server for guaranteeing the availability of said data network resources.

The user 503 can be one user that has created the data network resources 504, 505, 506, 507. In an alternative embodiment the user 503 comprises more than one person. In yet another embodiment the user 503 is not a person but an automatic document scanner generating data network resources from books and/or magazines.

FIG. 6 shows a graph and a minimal spanning tree in that graph.

In FIG. 6 six vertices are provided in a graph. Vertex a is connected to vertices b and c. Vertex b is connected to vertex c and e. Vertex c is connected to vertices e, d and f. Vertex d is connected to vertex e. Vertex e is connected to vertex a.

Finally vertex f is connected to vertices d and e. The term “connected” in this case means that an arrow is drawn from a first vertex being connected to the second vertex to which the first vertex is connected. In the graph vertices b and d are marked. The arrows between the vertices b, c and d are different to the remaining arrows.

In FIG. 6 a minimal spanning tree in the spanning tree comprising vertices a, b, c, d, e and f for the concepts a, c, e and f is comprised of the vertices a, c, e and f and the edges connecting vertices a and e, c and e and the edge connecting vertices c and f.

In FIG. 7 the idea of matching tags of data network resources with concepts of an ontology is detailed by an ontology 700 comprising concepts 701, 702, 703, 704, 705, wherein concept 701 is connected to concepts 702 and 703, concept 703 is connected to concepts 704 and 705. The ontology is coupled to resources 710, 711 and 712 which comprise a set 713 of tags t1, . . . , tn.

In FIG. 8 the a set PZK(i, j) 800 of potential concepts pzk(i, j, 1) for a tag t(i, j) is shown.

In FIG. 9 three sets 900, 901, 902 of potential concepts are shown. Each set of potential concepts is a set of potential concepts like the one shown in FIG. 8.

The benefits and advantages that may be provided by various embodiments have been described above with regard to specific embodiments. These benefits and advantages, and any elements or limitations that may cause them to occur or to become more pronounced are not to be construed as critical, required or essential features of any or all of the claims.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for matching data network resources with an appropriate group of concepts of an ontology comprising the steps of:
a) receiving a request indicating at least one expert field;
b) providing at least one data network resource of said expert field having at least one tag and an ontology of said expert field having at least one concept;
c) determining a minimum spanning tree of said concepts in said ontology corresponding to said tags of said data network resources; and
d) returning the concepts of said selected minimum spanning tree in response to the received request.

2. The method of claim 1, wherein the step of determining a minimum spanning tree comprises the following steps:
calculating a distance between each of said tags of said data network resources and each of at least one label corresponding to said concepts of said ontology;
selecting potential concepts for each tag for which the distance to said tag is lower than a distance threshold value and determining all n-tuples of said potential concepts for each tag, n being the number of tags of the respective data network resource; and
calculating a minimum spanning tree for each of said n-tuples and the sum of edge weights of said calculated minimum spanning tree and selecting the minimum spanning tree having the minimum sum of edge weights.

3. The method of claim 1, wherein each data network resource has a Unique Resource Identifier (URI) and comprises at least one of the following resources:
web pages,
web logs,
web forums,
news servers, and
documents.

4. The method of claim 1, wherein said tags comprise means configured to characterise the data network resource, wherein said means comprise at least one of:
terms of a natural language,
pictures,
figures, and
numbers.

5. The method of claim 2, wherein the step of calculating a distance comprises using at least one distance algorithm, said distance algorithm using at least one of the following string metrics:
Hamming distance,
Levenshtein distance and Damerau-Levenshtein distance,
Needleman-Wunsch distance or Sellers' algorithm,
Smith-Waterman distance,
Gotoh distance,
Monge Elkan distance,
Block distance or L1 distance or City block distance,
Jaro-Winkler distance,
Soundex distance metric,
Matching coefficient,
Dice's coefficient,
Jaccard similarity or Jaccard coefficient or Tanimoto coefficient,
Overlap coefficient,
Euclidean distance or L2 distance,
Cosine similarity,
Variational distance,
Hellinger distance or Bhattacharyya distance,
Information radius (Jensen-Shannon divergence),
Harmonic mean,
Skew divergence,
Confusion probability,
Tau metric, an approximation of the Kullback-Leibler divergence,
Fellegi and Sunters metric (SFS),
TFIDF or TF/IDF, and
Maximal matches.

6. The method of claim 2, wherein said distance threshold value is a value between 0 and 1, or a value between 0.5 and 0.9.

7. The method of claim 1, wherein said ontology comprises the Radlex Ontology or the Gene Ontology.

8. An apparatus for matching data network resources of a data network with an appropriate group of concepts of an ontology comprising:
a) at least one interface to said data network for receiving a request indicating at least one expert field from a requesting unit connected to said data network, wherein at least one data network resource comprising at least one tag is accessible by means of said network interface;
b) means for accessing a memory which stores at least one ontology of said expert field, said ontology comprising at least one concept; and
c) a minimum spanning tree determination unit provided to determine a minimum spanning tree of said concepts in the stored ontology corresponding to said tags of said data network resources;
d) wherein the concepts of said selected minimum spanning tree are returned by means of said network interface to said requesting unit.

9. The apparatus of claim 8, wherein the minimum spanning tree determination unit comprises:
a distance calculation unit provided to calculate a distance between each of said tags of said data network resources and each of the concepts of the stored ontology;
a selection unit provided to select potential concepts for each tag for which the calculated distance to said tag is lower than a distance threshold value;
a determination unit configured to determine all n-tuples of said potential concepts for each tag, n being the number of tags of the data network resource;
a spanning tree calculation unit adapted to calculate a minimum spanning tree for each of said determined n-tuples and the sum of edge weights of said calculated minimum spanning tree; and
a minimum spanning tree selection unit provided to select the minimum spanning tree having a minimum sum of edge weights.

10. The apparatus of claim 8, wherein each data network resource has a Unique Resource Identifier (URI) and comprises at least one of the following resources:
web pages,
web logs,
web forums,
news servers, and
documents.

11. The apparatus of claim 8, wherein said tags comprise means configured to characterise the data network resource, wherein said means comprise at least one of:
terms of a natural language,
pictures,
figures, and
numbers.

12. The apparatus of claim 9, wherein said distance calculation unit is adapted to calculate a distance using at least one distance algorithm, said distance algorithm using at least one of the following string metrics:
Hamming distance,
Levenshtein distance and Damerau-Levenshtein distance,
Needleman-Wunsch distance or Sellers' algorithm,
Smith-Waterman distance,
Gotoh distance,
Monge Elkan distance,
Block distance or L1 distance or City block distance,
Jaro-Winkler distance,
Soundex distance metric,
Matching coefficient,
Dice's coefficient,
Jaccard similarity or Jaccard coefficient or Tanimoto coefficient,
Overlap coefficient,
Euclidean distance or L2 distance,
Cosine similarity,
Variational distance,
Hellinger distance or Bhattacharyya distance,
Information radius (Jensen-Shannon divergence),
Harmonic mean,
Skew divergence,
Confusion probability,
Tau metric, an approximation of the Kullback-Leibler divergence,
Fellegi and Sunters metric (SFS),
TFIDF or TF/IDF, and
Maximal matches.

13. The apparatus of claim 9, wherein said apparatus comprises a configuration interface for adapting said distance threshold value to a value between 0 and 1, or a value between 0.5 and 0.9.

14. The apparatus of claim 8, wherein said apparatus is connected to said data network via said network interface by means of a wireless or wired link.

15. The apparatus of claim 8, wherein said apparatus is a server connected to the data network receiving the request from a client and returning concepts of the selected minimum spanning tree or the selected data network resources to said client.

16. A method for matching at least one concept of an ontology with an appropriate group of data network resources comprising the steps of:
a) receiving a request comprising at least one concept of an ontology of an expert field;
b) providing at least one data network resource corresponding to said expert field having at least one tag and an ontology corresponding to said expert field having at least one concept;
c) determining a minimum spanning tree of said concepts in said ontology corresponding to said tags of said data network resources;
d) providing a database configured to store pairs of said data network resources and said selected minimum spanning trees and storing calculated pairs of said resources comprising tags and said selected minimum spanning tree in said database;
e) selecting at least one data network resource matching said at least one concept based on data stored in said database; and
f) returning the selected data network resources corresponding to said at least one concept in response to the received request.

17. The method of claim 16, wherein the step of determining a minimum spanning comprises the following steps:
calculating a distance between each of said tags of said data network resources and each of at least one labels corresponding to said concepts of said ontology;
selecting potential concepts for each tag for which the distance to said tag is lower than a distance threshold value and determining all n-tuples of said potential concepts for each tag, n being the number of tags of the respective resource; and
calculating a minimum spanning tree for each of said n-tuples and the sum of the edge weights of said calculated minimum spanning tree and selecting the minimum spanning tree having the minimum sum of edge weights.

18. The method of claim 16, wherein each data network resource has a Unique Resource Identifier (URI) and comprises at least one of the following resources:
web pages,
web logs,
web forums,
news servers, and
documents.

19. The method of claim 16, wherein said tags comprise means configured to characterise the data network resource, wherein said means comprise at least one of:
terms of a natural language,
pictures,
figures, and
numbers.

20. The method of claim 17, wherein the step of calculating a distance comprises using at least one distance algorithm, said distance algorithm using at least one of the following string metrics:
Hamming distance,
Levenshtein distance and Damerau-Levenshtein distance,
Needleman-Wunsch distance or Sellers' algorithm,
Smith-Waterman distance,
Gotoh distance,
Monge Elkan distance,
Block distance or L1 distance or City block distance,
Jaro-Winkler distance,
Soundex distance metric,
Matching coefficient,
Dice's coefficient,
Jaccard similarity or Jaccard coefficient or Tanimoto coefficient,
Overlap coefficient,
Euclidean distance or L2 distance,
Cosine similarity,
Variational distance,
Hellinger distance or Bhattacharyya distance,
Information radius (Jensen-Shannon divergence),
Harmonic mean,
Skew divergence,
Confusion probability,
Tau metric, an approximation of the Kullback-Leibler divergence,
Fellegi and Sunters metric (SFS),
TFIDF or TF/IDF, and
Maximal matches.

21. The method of claim 17, wherein said distance threshold value is adjusted to a value between 0 and 1, or a value between 0.5 and 0.9.

22. An apparatus for matching at least one concept of an ontology with at least a single most appropriate group of data network resources of a data network comprising:
a) at least one network interface to said data network for receiving a request comprising at least one concept of an ontology of an expert field, wherein at least one data network resource comprising at least one tag is accessible by means of said network interface;
b) means for accessing a memory which stores at least one ontology of said expert field comprising at least one concept;
c) a minimum spanning tree determination unit provided to determine minimum spanning trees of said concepts in the stored ontology corresponding to said tags of said data network resources;
d) providing a database which stores pairs of said data network resources and said selected minimum spanning trees and which stores calculated pairs of said data network resources comprising tags and said selected minimum spanning tree; and
e) a resource selection unit configured to select at least one data network resource matching said at least one concept based on data stored in said database, wherein the selected data network resources correspond to said at least one concept and are returned by means of said network interface in response to the received request.

23. The apparatus of claim 22, wherein said minimum spanning tree determination unit comprises:
a distance calculation unit provided to calculate a distance between each of said tags of said data network resources and each of the concepts of the stored ontology;
a selection unit provided to select potential concepts for each tag for which the calculated distance to said tag is lower than a distance threshold value and a determination unit adapted to determine all n-tuples of said potential concepts for each tag, n being the number of tags of the resource;
a spanning tree calculation unit adapted to calculate a minimum spanning tree for each of said determined n-tuples and the sum of edge weights of said calculated minimum spanning tree; and
a minimum spanning tree selection unit configured to select the minimum spanning tree having a minimum sum of edge weights.

24. An expert system comprising at least one apparatus according to claim 8.

25. An expert system comprising at least one apparatus according to claim 22.
